(19) United States
(12) Patent Application Publication
(10) Pub. No.: US 2011/0229853 A1
(43) Pub. Date: Sep. 22, 2011

(54) SCREW FOR TOOTH IMPLANTING

(76) Inventor: Chun-Leon CHEN, Changhua City (TW)

(21) Appl. No.: 12/725,971

(22) Filed: Mar. 17, 2010

(51) Int. Cl. A61C 8/00

(52) U.S. Cl. 433/174

(57) ABSTRACT

A screw used in tooth implanting, it is used to screw tight an implant root and an abutment, and is comprised of a threaded shank and a screw head; the threaded shank has a screw thread on its surface; and the screw head is formed on the top end of the threaded shank, and is formed at its central area a hexagonal recess of which at least an edge is inwardly arched toward its center. The six corners of the hexagonal recess of the screw head are sharp angles which provide better supporting strength against being easily damaged, in order that well locking together of the implant root and the abutment is assured.

### BACKGROUND OF THE INVENTION

1. Field of the Invention

The present invention relates to a screw used in tooth implanting, and especially to a screw of which a screw head is formed at its central area a hexagonal recess with edges arched inwardly toward its center in order to reduce corner damage.

2. Description of the Prior Art

In an tooth implanting operation, a fixture (implant root) 93 is implanted in a gingiva in advance, then an implanting screw 90 is used to lock an abutment 94 on the implant root 93, lastly, an artificial tooth crown is mounted on the abutment 94, and the tooth implanting operation is completed such as is shown in FIG. 2.

FIG. 1 shows a conventional tooth implanting screw 90 mainly composed of a screw head 91 and a threaded shank 92 with a screw thread, the screw head 91 has therein a hexagonal recess 911, a tool can be extended into the hexagonal recess 911 for screwing tight. The volume of the tooth implanting screw 90 is very small; when the tooth implanting screw 90 is used to screw tight the two parts including the implant root 93 and the abutment 94, it will exert rotational twisting force on the hexagonal recess 911 of the screw head 91, the hexagonal recess 911 is a right hexagon, its six edges are straight linear edges, when a rotating force is exerted, the corners of the hexagonal recess 911 are subjected to largest force components, and normally damages are resulted easily. If the hexagonal recess 911 of the screw head 91 is damaged, the abutment 94 is unable to be fixed to induce a result of failure of operation. Therefore, it is the main talking-over category of the present invention about how to provide a screw used in tooth implanting to reduce damages of the corners.

### SUMMARY OF THE INVENTION

The present invention provides a screw used in tooth implanting, the screw is used to screw tight an implant root and an abutment, and is comprised of:
a threaded shank with a screw thread on its surface; and
a screw head formed on the top end of the threaded shank, and formed at its central area a hexagonal recess at least with an edge arched inwardly toward its center.

The primary object of the present invention is to provide a screw used in tooth implanting, the six corners of the hexagonal recess of the screw head are sharp angles which provide better supporting strength against being easily damaged, in order that well locking together of the implant root and the abutment is assured.

The present invention will be apparent in its structural feature and its effect of using after reading the detailed description of the preferred embodiment thereof in reference to the accompanying drawings.

### BRIEF DESCRIPTION OF THE DRAWINGS

FIG. 1 is a perspective view showing the appearance of a conventional screw used in tooth implanting;

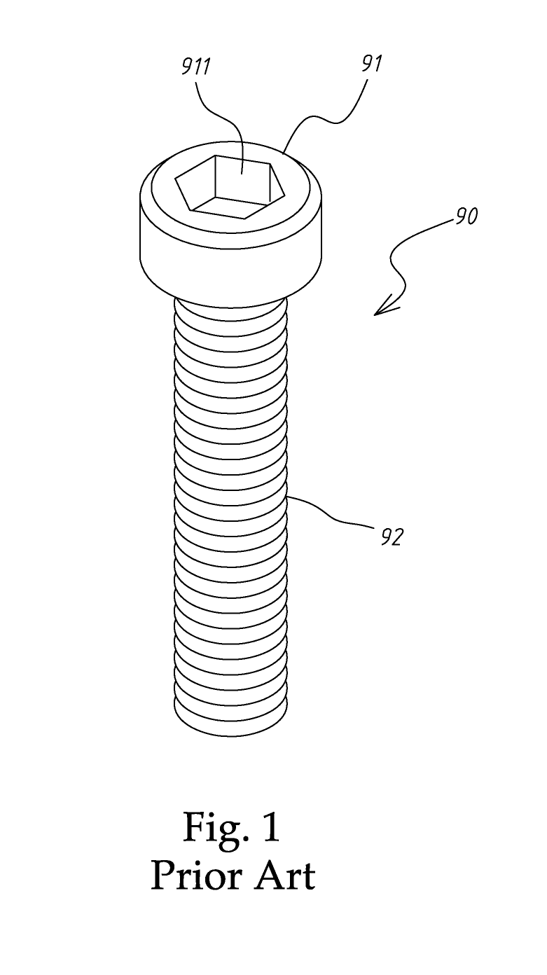

FIG. 2 is a sectional view of the conventional screw used in tooth implanting operation;

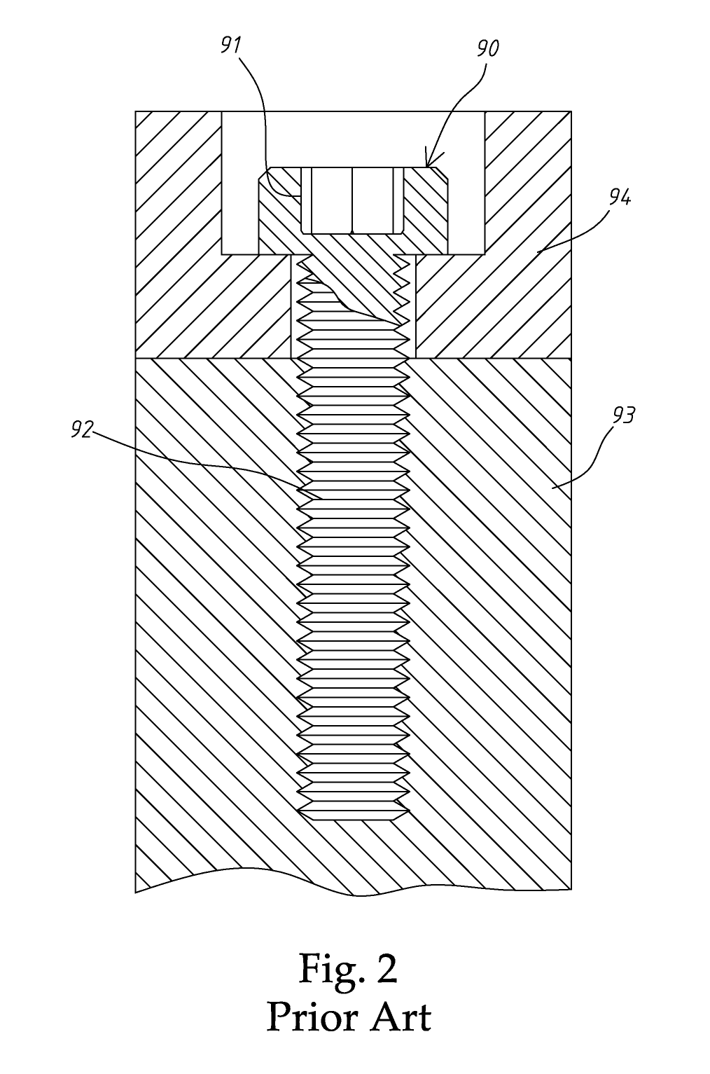

FIG. 3 is a perspective view of the present invention;

FIG. 4 is a bottom view of the present invention.

### DETAILED DESCRIPTION OF THE PREFERRED EMBODIMENT

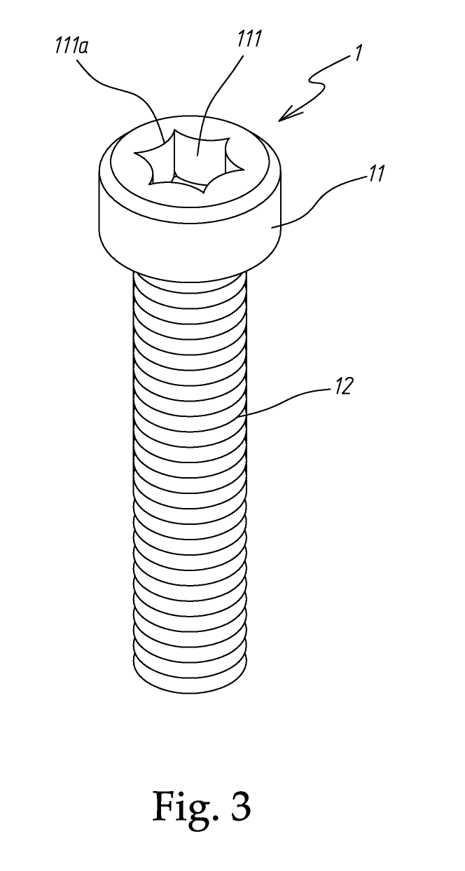

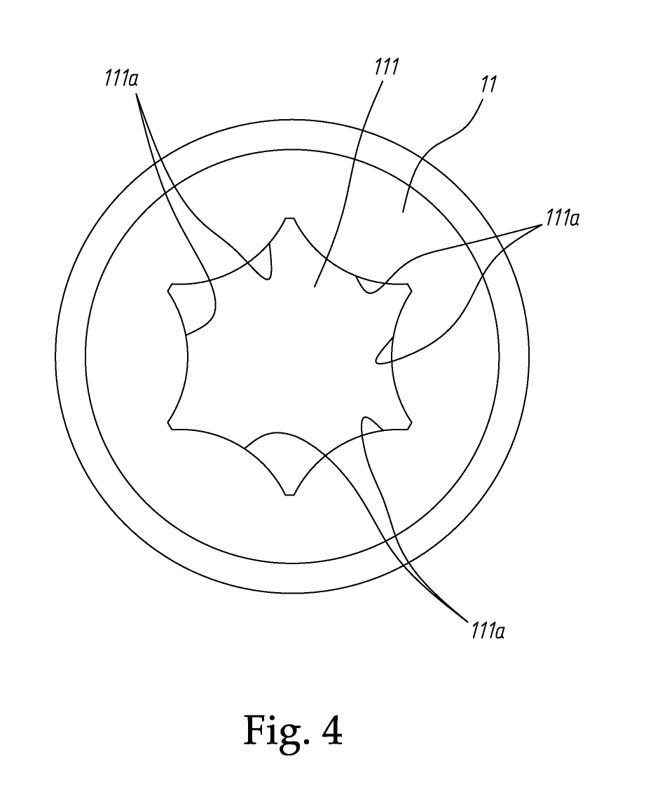

Referring to FIGS. 3 and 4, a screw 1 used in tooth implanting of the present invention is used to screw tight an implant root 93 and an abutment 94, and is comprised of a screw head 11 and a threaded shank 12.

The threaded shank 12 has a screw thread on its surface, the screw head 11 is formed on the top end of the threaded shank 12, and is formed at its central area a hexagonal recess 111 at least with an edge arched inwardly toward its center. It is shown in the drawing that all the six edges 111a are inwardly arched, surely it can also be that at least one of the edges 111a is inwardly arched toward its center or that some mutually opposite edges 111a are inwardly arched, all these come from variable designing of the present invention.

By virtue that the edges 111a of the hexagonal recess 111 of the screw head 11 are inwardly arched, when in screwing tight the screw 1 used in tooth implanting, the corners of the hexagonal recess 111 of the screw head 11 can have better supporting strength being not subjected to damaging, so that the hexagonal recess 111 can afford bearing larger rotation twisting force. Particularly, by virtue that the threaded shank 12 and the screw head 11 have very small volumes, the inwardly arched edges 111a of the hexagonal recess 111 can assure the six corners are not subjected to damaging, and operation of tooth implanting can be smoothly progressed.

In conclusion, the screw used in tooth implanting of the present invention can reduce damaging of its corners; therefore, the present invention meets the requirement of patentable elements, and what we claim will be declared in the claims followed.

1. A screw used in tooth implanting, said screw is used to screw tight an implant root and an abutment, and is comprised of:
a threaded shank with a screw thread on its surface; and
a screw head formed on a top end of said threaded shank, and formed at its central area a hexagonal recess at least with an edge arched inwardly toward its center.

2. The screw used in tooth implanting as claimed in claim 1, wherein six edges of said hexagonal recess all are inwardly (toward said center) arched edge.
